(19) United States
(12) Patent Application Publication
(10) Pub. No.: US 2021/0074496 A1
(43) Pub. Date: Mar. 11, 2021

(54) Gas Circuit Breaker

(71) Applicant: Hitachi, Ltd., Tokyo (JP)

(72) Inventors: Masanori ISHIKAWA, Tokyo (JP); Eiji ISHII, Tokyo (JP); Takahiro NISHIMURA, Tokyo (JP)

(21) Appl. No.: 16/935,958

(22) Filed: Jul. 22, 2020

(30) Foreign Application Priority Data
Sep. 5, 2019 (JP) 2019-161723

(51) Int. Cl. H01H 33/70; H01H 33/56

(52) U.S. Cl. CPC H01H 33/7015; H01H 33/56

(57) ABSTRACT

To attempt to reduce the sizes of apparatuses while ensuring insulation performance with simpler configurations. In a gas circuit breaker according to the present invention, a high-temperature-gas guiding section is provided at an axial-end section of a fixed main conductor that is connected to a fixed lead conductor connected to a power system, and that has an open section for discharging an insulating gas having an increased temperature and an increased pressure due to an arc produced at the time of interruption. The high-temperature-gas guiding section has a plurality of holes for discharging, into a filled container, a high-temperature gas produced by heating the insulating gas filling the filled container, and is formed such that the directions of the plurality of holes are oblique to the axial direction of the fixed main conductor.

### CLAIM OF PRIORITY

The present application claims priority from Japanese Patent application serial no. 2019-161723, filed on Sep. 5, 2019, the content of which is hereby incorporated by reference into this application.

### BACKGROUND OF THE INVENTION

### 1. Field of the Invention

The present invention relates to gas circuit breakers, and in particular relates to gas circuit breakers that are suitable for ones including a high-temperature-gas guiding section having a plurality of holes for discharging, into a filled container, a high-temperature gas produced by heating an insulating gas having an increased temperature and an increased pressure due to an arc produced at the time of interruption.

### 2. Description of the Related Art

Gas circuit breakers are equipment for interrupting short-circuit currents produced due to phase-to-phase short circuiting, earth fault or the like in a power system, and puffer-type gas circuit breakers have conventionally been used widely.

The puffer-type gas circuit breakers are configured to generate a high-pressure gas flow by mechanically compressing an arc-extinguishing gas with a drive puffer cylinder directly coupled with a movable arc contact. Then, the high-pressure gas flow is blown onto an arc generated between the movable arc contact and a fixed arc contact to interrupt a current.

It is known that normally, the interruption performance of gas circuit breakers depends on pressure increase in their puffer chambers. In view of this, a gas circuit breaker combined with a thermal puffer is also widely used for increasing pressure by actively using the thermal energy of an arc in addition to conventional pressure increase by mechanical compression.

The gas circuit breaker combined with a thermal puffer forms a blowing pressure of an arc-extinguishing gas by using the thermal energy of an arc in addition to the pressure produced by mechanical compression, and can reduce the operation energy required for interruption operation as compared with a conventional manner in which mechanical compression is used singly.

Typically, in the gas circuit breaker combined with a thermal puffer, two pressure-increasing chambers including a pressure-increasing chamber with a fixed volume for taking in the thermal energy of an arc at the time of current interruption (called a thermal puffer chamber) and a pressure-increasing chamber having a volume that becomes smaller due to mechanical compression at the time of the current interruption (called a mechanical puffer chamber) are arranged in series, and these two pressure-increasing chambers communicate with each other via a check valve.

A high-temperature gas heated by an arc generated between a movable arc contact and a fixed arc contact is eventually discharged into the inner-circumference spaces of movable and fixed conductors and a filled container via the inner-circumference spaces of the movable and fixed conductors, along with a gas introduced into the thermal puffer chamber and used also for forming the blowing pressure.

The high-temperature gas heated by the arc mentioned above is mixed with low-temperature gases originally present in the inner-circumference spaces of the conductors and in the filled container, and is cooled when the high-temperature gas is discharged into the inner-circumference spaces of the conductors and the filled container. However, in a case where the high-temperature gas is not cooled sufficiently, deterioration of the performance in terms of insulation of the conductors and the filled container from the earth occurs, and accordingly the structure for cooling the discharged high-temperature gas is important.

As a structure for enhancing cooling of high-temperature gases, for example, there is known a structure described in JP-1998-275543-A in which a plurality of blades are arranged in the space in a conductor, and a high-temperature gas flow is caused to swirl in the space in the conductor to thereby enhance mixing of the high-temperature gas and a low-temperature gas.

On the other hand, in a gas circuit breaker described in JP-2017-123315-A, a plurality of gas rectifying sections each having a plurality of vane structures for forming a swirling flow in the space in a stator-side conductor are installed in a flow path such that the swirling directions of the swirling flows alternate between different directions.

In the gas circuit breaker described in JP-1998-275543-A mentioned above, a plurality of discharge guides having vane shapes are arranged on the stator side cylindrically as a whole to thereby form a discharge cylinder.

However, since a high-temperature gas is discharged in the circumferential direction relative to the central axis of the breaker, it is difficult to apply the configuration in cases where there is a high-electric field section such as a base section of a lead conductor on the circumferential side.

In addition, in the configuration of JP-2017-123315-A mentioned above, since the gas rectifying sections are provided with a number of vanes, the structure becomes complicated. Moreover, since the vanes are formed to have thin tabular structures, it is difficult to maintain the strength of the vanes.

Additionally, since the structure is intended to enhance mixing of gases in a fixation support equivalent to a fixed main conductor, when a gas is discharged from the fixed main conductor into a filled container, the gas is discharged only in the direction of the side surface of the fixation support from open sections on the side surface. Regarding mixing with a low-temperature gas between the stator-side conductor and the filled container, it is supposed that sufficient cooling has been completed in the fixation support.

The present invention has been made in view of the matters mentioned above, and an object thereof is to provide gas circuit breakers that make it possible to reduce the sizes of apparatuses while ensuring insulation performance with simpler configurations.

### SUMMARY OF THE INVENTION

In order to achieve the object described above, a gas circuit breaker according to the present invention is a gas circuit breaker that blows an insulating gas having an arc-extinguishing property onto an arc produced at a time of interruption, and extinguishes the arc, the gas circuit breaker including: a filled container filled with the insulating gas; a fixed main conductor that is connected to a fixed lead conductor connected to a power system, and has an open section for discharging the insulating gas having an increased temperature and an increased pressure due to the arc produced at the time of the interruption; a movable main conductor that is supported by and fixed to an insulating support tube arranged inside the filled container, is connected to a movable lead conductor connected to the power system, and has a discharge hole for discharging the insulating gas; a movable contact electrically connected to the movable lead conductor; a fixed contact that is electrically connected to the fixed lead conductor connected to the power system, and can come into contact with and be separated from the movable contact; and a high-temperature-gas guiding section that is provided at an axial-end section of the fixed main conductor, and has a plurality of holes for discharging, into the filled container, a high-temperature gas produced by heating the insulating gas. The high-temperature-gas guiding section is formed such that directions of the plurality of holes are oblique to an axial direction of the fixed main conductor.

In addition, in order to achieve the object described above, a gas circuit breaker according to the present invention is a gas circuit breaker that blows an insulating gas having an arc-extinguishing property onto an arc produced at a time of interruption, and extinguishes the arc, the gas circuit breaker including: a filled container filled with the insulating gas; a fixed main conductor that is connected to a fixed lead conductor connected to a power system, and has an open section for discharging the insulating gas having an increased temperature and an increased pressure due to the arc produced at the time of the interruption; a movable main conductor that is supported by and fixed to an insulating support tube arranged inside the filled container, is connected to a movable lead conductor connected to the power system, and has a discharge hole for discharging the insulating gas; a movable contact electrically connected to the movable lead conductor; a fixed contact that is electrically connected to the fixed lead conductor connected to the power system, and can come into contact with and be separated from the movable contact; and a high-temperature-gas guiding section that is provided at an axial-end section of the fixed main conductor, and has a plurality of holes for discharging, into the filled container, a high-temperature gas produced by heating the insulating gas. The high-temperature-gas guiding section includes a base section, and the plurality of holes that are formed in pipe-like forms protruding from the base section in an axial direction, and is formed such that directions of the plurality of holes formed in the pipe-like forms are oblique to an axial direction of the fixed main conductor.

According to the present invention, it is possible to attempt to reduce the sizes of apparatuses while ensuring insulation performance with simpler configurations.

### BRIEF DESCRIPTION OF THE DRAWINGS

FIG. 1 is a cross-sectional diagram illustrating the schematic configuration of a gas circuit breaker according to the present invention in a closed state in a first embodiment;

FIG. 2 is a cross-sectional diagram of the gas circuit breaker illustrating the flow of an insulating gas in an opened state in the first embodiment of the gas circuit breaker according to the present invention;

FIG. 3A is a schematic configuration diagram illustrating solely a high-temperature-gas guiding section in the first embodiment of the gas circuit breaker according to the present invention;

FIG. 3B is a diagram as seen in the direction of the arrow A in FIG. 3A;

FIG. 3C is a cross-sectional diagram taken along the line B-B′ in FIG. 3B;

FIG. 4 is a diagram illustrating the shape of the high-temperature-gas guiding section in the first embodiment of the gas circuit breaker according to the present invention as seen from another direction in such a manner that the positional relationship between the directions of a plurality of high-temperature-gas guiding holes and the axial direction of a fixed main conductor can be easily understood;

FIG. 5A is a schematic configuration diagram illustrating solely the high-temperature-gas guiding section in a second embodiment of the gas circuit breaker according to the present invention;

FIG. 5B is a diagram as seen in the direction of the arrow A in FIG. 5A;

FIG. 5C is a cross-sectional diagram taken along the line B-B′ in FIG. 5B; and

FIG. 6 is a perspective view illustrating a partial cross-section of the high-temperature-gas guiding section in a third embodiment of the gas circuit breaker according to the present invention.

### DESCRIPTION OF THE PREFERRED EMBODIMENTS

In the following, a gas circuit breaker according to the present invention is explained on the basis of illustrated embodiments. Note that the same reference symbols are used for identical components throughout the embodiments explained below.

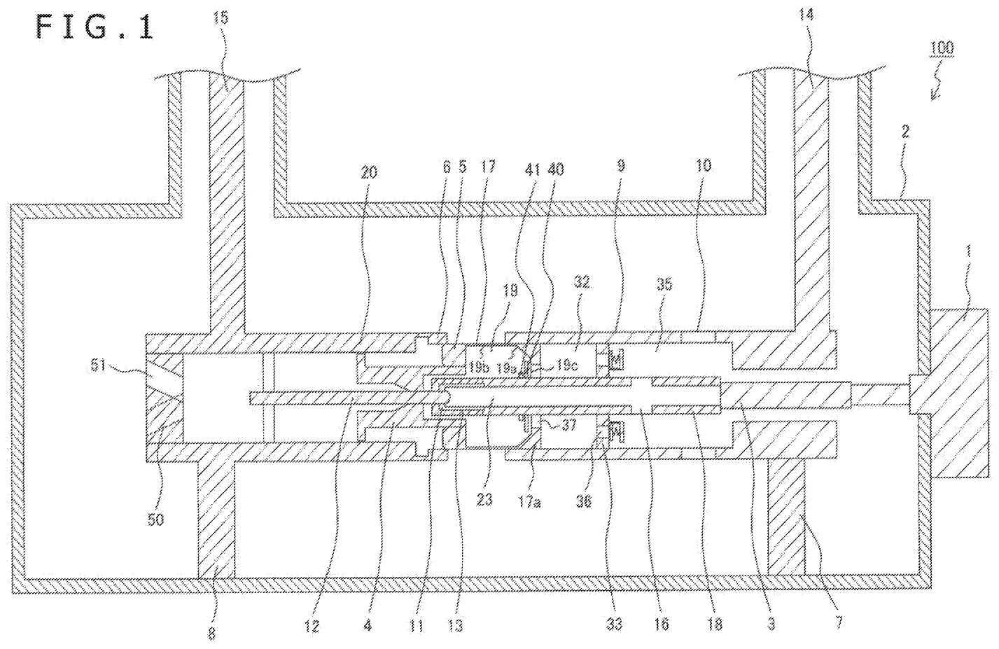

In addition, the “axial direction” in the specification of the present invention refers to the direction of the central axis of cylinders forming fixed and movable main conductors (the leftward and rightward (horizontal) directions in FIG. 1). In the following, the “axial direction” has the same meaning unless particularly specified otherwise.

### First Embodiment

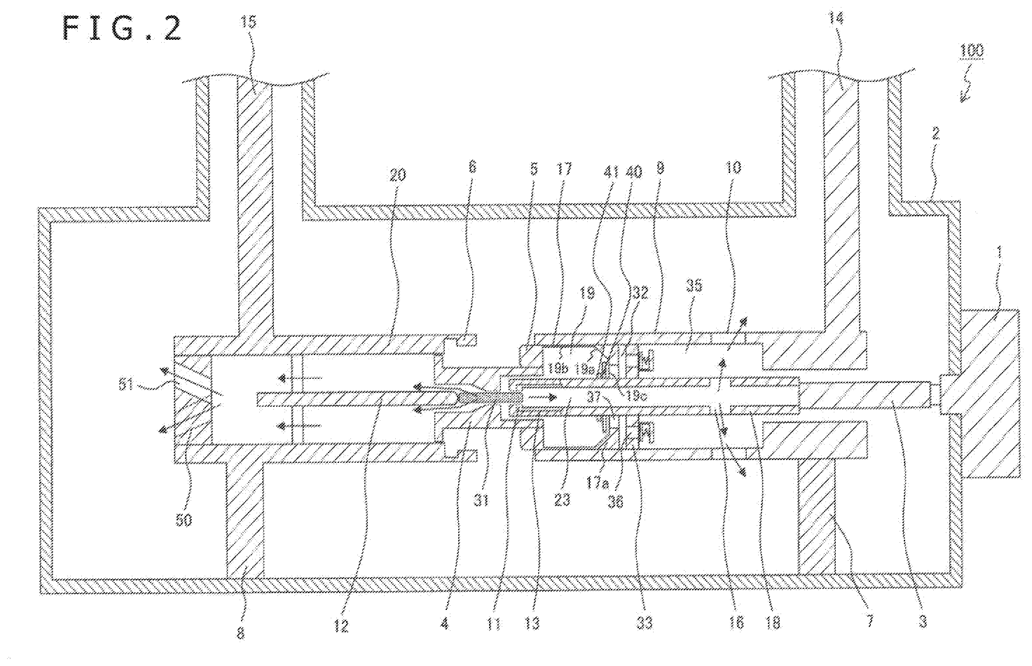

FIG. 1 and FIG. 2 illustrate the schematic configuration of a first embodiment of a gas circuit breaker 100 according to the present invention. FIG. 1 illustrates the closed state of the gas circuit breaker 100, and FIG. 2 illustrates the opened state of the gas circuit breaker 100.

The gas circuit breaker 100 of the present embodiment illustrated in FIG. 1 and FIG. 2 is arranged at an intermediate section of a power system (a high-voltage circuit, and the like), and stops energization of the power system by cutting off electricity in the power system when a short-circuit current is generated due to lightning or the like. The gas circuit breaker 100 illustrated in FIG. 1 and FIG. 2 is an example of puffer-type gas circuit breakers.

The gas circuit breaker 100 of the present embodiment illustrated in FIG. 1 and FIG. 2 includes: a filled container 2 filled with an insulating gas having an arc-extinguishing property (e.g. a sulfur hexafluoride gas); a movable main conductor 9 that is supported by and fixed to an insulating support tube 7 arranged inside the filled container 2, is connected to a movable lead conductor 14 connected to the power system (high-voltage circuit), and has a discharge hole 10 for discharging the insulating gas having an increased temperature and an increased pressure due to an arc 31 (see FIG. 2) produced at the time of interruption; a discharge shaft 18 that is provided inside the movable main conductor 9 so as to be movable in the axial direction of the movable main conductor 9, and has a shaft discharge hole 16 for discharging the insulating gas having the increased temperature and the increased pressure; an operation mechanism 1 that is coupled to the discharge shaft 18, and outputs operation force in the axial direction of the discharge shaft 18 via an operation rod 3; a cylinder 17 that is coupled coaxially with the discharge shaft 18, and can slide on the inner-circumference surface of the movable main conductor 9 in the axial direction; a puffer piston 33 that is fixed inside the movable main conductor 9, is open in the axial direction of the movable main conductor 9, and has, at the open section, an inner-circumference surface on which the discharge shaft 18 can slide; a movable main contact 5 that is electrically connected to the movable lead conductor 14 via the cylinder 17 and the movable main conductor 9; and a fixed main contact 6 that is electrically connected to a fixed lead conductor 15 connected to the power system, and can come into contact with and be separated from the movable main contact 5.

Then, the movable contact has the movable main contact 5, an insulating nozzle 4 and a movable arc contact 11, the fixed contact has the fixed main contact 6 and a fixed arc contact 12, and the movable arc contact 11 is connected to the operation mechanism 1 via the discharge shaft 18 and the operation rod 3.

Explaining more specifically, the gas circuit breaker 100 of the present embodiment includes the movable main conductor 9, the discharge shaft 18, the cylinder 17 and the puffer piston 33, and these are arranged inside the filled container 2 filled with the insulating gas (e.g. a sulfur hexafluoride gas) having an arc-extinguishing property. On the front side of the discharge shaft 18 (the left side of FIG. 1 and FIG. 2), the movable main contact 5 and the movable arc contact 11 (both of which are equivalent to the movable contact) are provided. These are electrically connected to the movable lead conductor 14 connected to the power system.

Then, the fixed main contact 6 and the fixed arc contact 12 (both of which are equivalent to the fixed contact) that can come into contact with and be separated from the movable main contact 5 and the movable arc contact 11 are supported by and fixed to a fixed main conductor 20 supported by and fixed to the fixed insulation tube 8, and are electrically connected to the fixed lead conductor 15 connected to the power system.

Accordingly, at the time of an occurrence of a short-circuit current mentioned above due to lightning or the like, the movable main contact 5 and the movable arc contact 11 are separated from the fixed main contact 6 and the fixed arc contact 12 to thereby stop energization of the power system (this state is illustrated in FIG. 2).

The movable main conductor 9 mentioned above is supported by and fixed to the insulating support tube 7 arranged inside the filled container 2. The movable main conductor 9 has a cylindrical shape, and has an inner space in which the cylinder 17 can slide. In addition, the side surface of the movable main conductor 9 has the discharge hole 10 formed for discharging the high-temperature and high-pressure insulating gas from the inside of the movable main conductor 9 into the inside of the filled container 2.

The high-temperature and high-pressure insulating gas is produced by the insulating gas being heated and pressurized by the arc 31 generated when the movable arc contact 11 is separated from the fixed arc contact 12 as illustrated in FIG. 2.

In addition, the discharge shaft 18 is hollow, and provided inside the movable main conductor 9 coaxially with the movable main conductor 9. A flow path 23 for allowing the high-temperature and high-pressure gas produced due to the arc 31 to flow therethrough is formed inside the discharge shaft 18. On the side surface of the rear side (the right side of FIG. 1 and FIG. 2) of the discharge shaft 18, the shaft discharge hole 16 is formed for discharging, to the outside of the discharge shaft 18, the high-temperature and high-pressure gas having flowed through the flow path 23 described above.

In addition, the operation mechanism 1 that outputs operation force in the axial direction of the discharge shaft 18 is coupled to the discharge shaft 18 (in FIG. 1 and FIG. 2, the operation mechanism 1 is coupled to the discharge shaft 18 via the operation rod 3).

Then, at the time when a short-circuit current is produced or at other timing, the operation mechanism 1 receives an input of an instruction for movement from an output unit which is not illustrated. In response to the instruction for movement from the output unit, the operation mechanism 1 moves the discharge shaft 18 backward (the right side of FIG. 1 and FIG. 2) via the operation rod 3 to thereby separate the movable main contact 5 and the movable arc contact 11 from the fixed main contact 6 and the fixed arc contact 12, and interrupt the power system (this state is illustrated in FIG. 2).

In addition, the cylinder 17 is coupled to the discharge shaft 18 such that the cylinder 17 becomes coaxial with the discharge shaft 18, and the cylinder 17 can slide inside the cylindrical movable main conductor 9 along with the movement of the discharge shaft 18 in the axial direction.

In addition, on the rear side (the right side of FIG. 1 and FIG. 2) of the cylinder 17, a piston 17a that is formed integrally with the cylinder 17 is arranged. A mechanical puffer chamber 32 is formed between the piston 17a and the puffer piston 33 and inside the movable main conductor 9. Accordingly, a backward movement of the cylinder 17 along with the discharge shaft 18 results in compression of the insulating gas inside the mechanical puffer chamber 32.

In addition, a thermal puffer chamber 19 is formed inside the cylinder 17 and on the front side (the left side of FIG. 1 and FIG. 2) of the piston 17a, and the high-temperature and high-pressure gas produced due to the arc 31 is guided to the thermal puffer chamber 19.

The thermal puffer chamber 19 and the mechanical puffer chamber 32 that are described above, and a movable-conductor inner-circumference space 35 communicate with each other in the order of the thermal puffer chamber 19, the mechanical puffer chamber 32 and the movable-conductor inner-circumference space 35 in series through a first hole 36 and a second hole 37 formed to surround the discharge shaft 18.

In addition, an end section of the thermal puffer chamber 19 closer to the mechanical puffer chamber 32 is provided with a check valve 40. The check valve 40 moves between a stopper 41 and a mechanical-puffer-chamber-side end section 19c of the thermal puffer chamber 19. When the check valve 40 and the inner wall of the thermal puffer chamber 19 come into contact with each other, the second hole 37 is closed.

In addition, a mechanical-puffer-chamber-side outer-circumference section 19a of the thermal puffer chamber 19 is inclined to an outer-circumference section 19b of the thermal puffer chamber 19 and the mechanical-puffer-chamber-side end section 19c of the thermal puffer chamber 19. That is, the mechanical-puffer-chamber-side outer-circumference section 19a of the thermal puffer chamber 19 is formed so as to be inclined such that the length of the thermal puffer chamber 19 in the radial direction decreases from the outer-circumference section 19b of the thermal puffer chamber 19 toward the mechanical-puffer-chamber-side end section 19c of the thermal puffer chamber 19.

In addition, the movable main contact 5 is arranged at the front tip (the left tip in FIG. 1 and FIG. 2) of the cylinder 17, and a movable arc contact 11 is arranged at the front tip (the left tip in FIG. 1 and FIG. 2) of the discharge shaft 18 such that the movable arc contact 11 is surrounded by the movable main contact 5.

The movable arc contact 11 described above faces the inside of the discharge shaft 18 (i.e. the flow path 23), and the movable arc contact 11 is covered with a drive cover 13. Then, the insulating nozzle 4 is arranged at the front tip (the left tip in FIG. 1 and FIG. 2) of the cylinder 17 such that insulating nozzle 4 surrounds the movable arc contact 11 and the fixed arc contact 12.

In addition, the puffer piston 33 is a disk-like member fixed to the inside of the movable main conductor 9. Moreover, the center of, and a portion near the center of the puffer piston 33 are open, and the discharge shaft 18 is inserted into the open section. Thereby, the discharge shaft 18 can slide on the inner side surface of the open section of the fixed puffer piston 33, and move in the axial direction.

On the other hand, regarding the fixed side, the high-temperature gas produced due to the arc 31 generated at the time of separation of the movable arc contact 11 from the fixed arc contact 12 is discharged to the inner-circumference space of the fixed main conductor 20 via the space between the inner circumference of the insulating nozzle 4 and the outer circumference of the fixed arc contact 12.

Note that the fixed arc contact 12 is fixed completely in some cases, and is coupled to a twin-drive mechanism that moves in conjunction with movements of the movable side in other cases, and the present invention can be applied to both the cases.

Then, the high-temperature gas (illustrated by arrows in FIG. 2) discharged to the inner-circumference space of the fixed main conductor 20 moves in the axial direction while being mixed with a low-temperature gas present in the fixed main conductor 20, reaches a high-temperature-gas guiding section 50 (the high-temperature-gas guiding section 50 is provided integrally with or separately from the fixed main conductor 20; in the present embodiment, the high-temperature-gas guiding section 50 is provided separately from the fixed main conductor 20) and is discharged into the filled container 2 via a plurality of columnar high-temperature-gas guiding holes 51 formed through the high-temperature-gas guiding section 50.

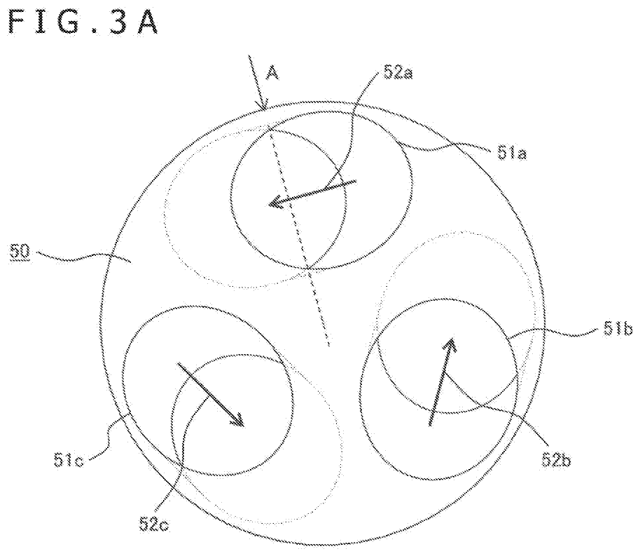

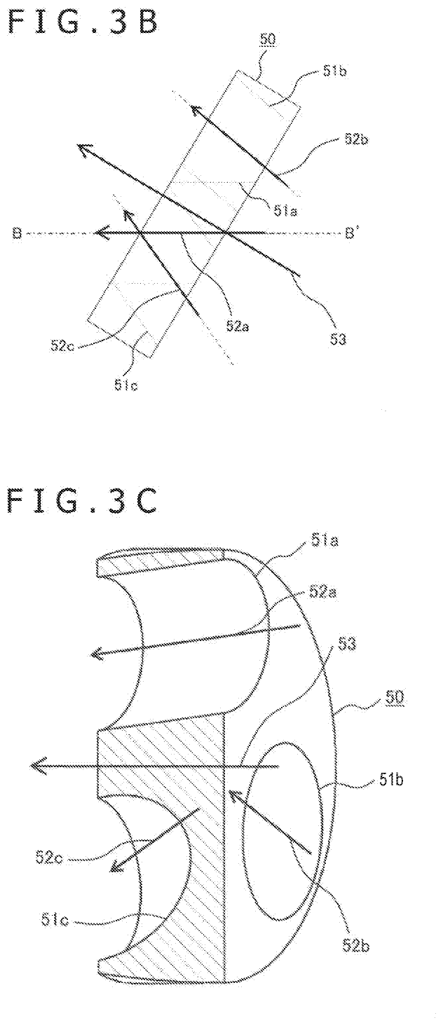

Details of the high-temperature-gas guiding section 50 mentioned above are illustrated in FIG. 3A, FIG. 3B and FIG. 3C. FIG. 3A is a schematic configuration diagram illustrating solely the high-temperature-gas guiding section 50. FIG. 3B is a diagram as seen in the direction of the arrow A in FIG. 3A. FIG. 3C is a cross-sectional diagram taken along the line B-B′ in FIG. 3B.

As illustrated in FIG. 3A, FIG. 3B and FIG. 3C, the high-temperature-gas guiding section 50 of the present embodiment has the plurality of columnar high-temperature-gas guiding holes 51 (three high-temperature-gas guiding holes 51a, 51b and 51c in the present embodiment) that are formed at approximately equal intervals in the circumferential direction of the high-temperature-gas guiding section 50, and is formed such that directions 52a, 52b and 52c of the high-temperature-gas guiding holes 51a, 51b and 51c are oblique to an axial direction 53 of the fixed main conductor 20.

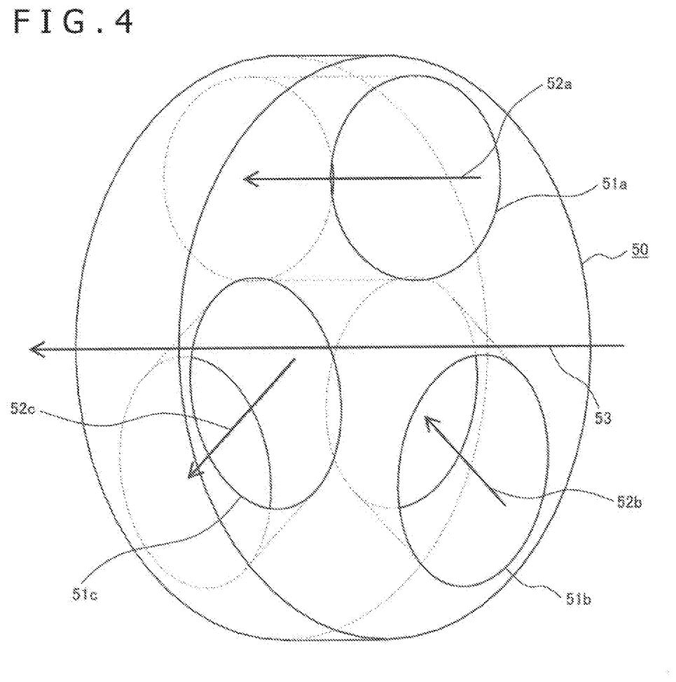

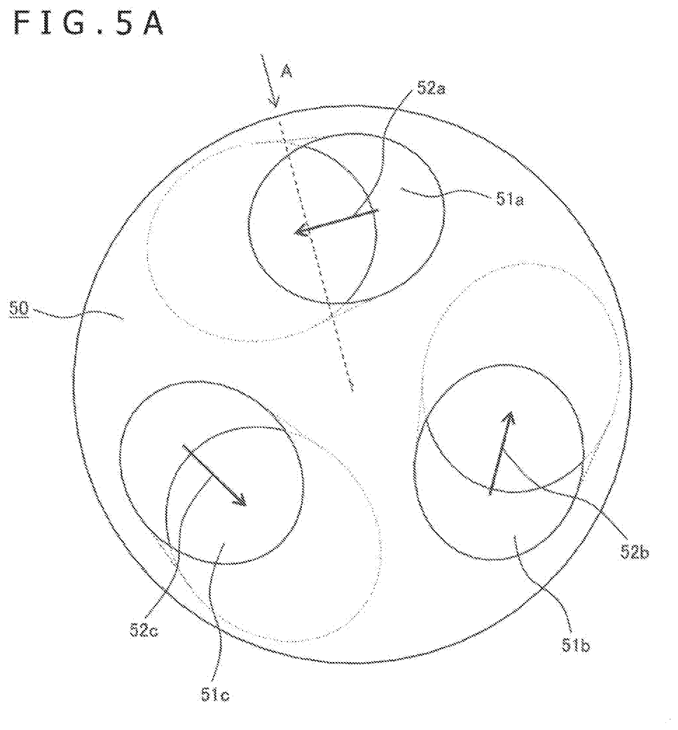

This is explained by using FIG. 4. FIG. 4 is a diagram illustrating the shape of the high-temperature-gas guiding section 50 illustrated in FIG. 3A, FIG. 3B and FIG. 3C as seen from another direction in such a manner that the positional relationship between the directions 52a, 52b and 52c of the high-temperature-gas guiding holes 51a, 51b and 51c and the axial direction 53 of the fixed main conductor 20 can be easily understood.

As illustrated in FIG. 4, in the present embodiment, the directions 52a, 52b and 52c of the high-temperature-gas guiding holes 51a, 51b and 51c formed at approximately equal intervals in the circumferential direction of the high-temperature-gas guiding section 50 are formed such that the directions 52a, 52b and 52c of the high-temperature-gas guiding holes 51a, 51b and 51c are oblique to the axial direction 53 of the fixed main conductor 20, and the axial direction 53 of the fixed main conductor 20 and the directions 52a, 52b and 52c of the high-temperature-gas guiding holes 51a, 51b and 51c do not cross, that is, have a relationship of skew lines (the high-temperature-gas guiding holes 51a, 51b and 51c have skew central axes such that the directions of the flows of the discharged high-temperature gas become unaligned). The high-temperature gas having passed through the high-temperature-gas guiding holes 51a, 51b and 51c forms a gas flow having a swirling flow component in the circumferential direction orthogonal to the axial direction.

With the thus-formed high-temperature-gas guiding section 50, the high-temperature gas having a flow rate in the swirling direction spreads in the circumferential direction, and the flow rate in the axial direction lowers by an amount corresponding to the increase in the flow rate in the swirling direction. Accordingly, the arrival distance, in the axial direction, of the high-temperature gas becomes shorter due to effects of the spread and the decrease.

In addition, the area of contact between the low-temperature gas and the high-temperature gas is increased because there are a plurality of high-temperature-gas guiding holes 51a, 51b and 51c, and the effect of mixing the hot-temperature gas with the surrounding low-temperature gas can be enhanced because the swirling flow is formed. Accordingly, the performance of cooling the high-temperature gas can be improved.

Additionally, as compared with a structure like the one having a plurality of vanes formed with thin plates described in JP-2017-123315-A, great strength can be ensured for the high-temperature-gas guiding section 50 in terms of vanes or attachment sections (i.e. since the high-temperature-gas guiding section 50 of the present embodiment does not have vanes, the structure is simplified, and since the thickness can be increased, the strength can be increased). Strength can also be ensured against the pressure increase in the fixed main conductor 20 due to the high-temperature gas.

Due to the effect mentioned above, in conventional structures without the high-temperature-gas guiding section 50 or in cases where sections that are open in the axial direction of the fixed main conductor 20 (open sections parallel to the axial direction) are provided, a high-temperature gas advances straight directly in the axial direction. Accordingly, it is necessary to make sure that there is a long distance between the fixed main conductor 20 and the filled container 2 for ensuring insulation between the fixed main conductor 20 and the filled container 2.

In contrast to this, it becomes possible in the gas circuit breaker illustrated in present embodiment to lower the temperature of the high-temperature gas discharged from the fixed main conductor 20, and to make shorter the arrival distance, in the axial direction, of the high-temperature gas, due to the effects of the high-temperature-gas guiding section 50. Accordingly, it becomes possible to make shorter the distance for ensuring insulation between the fixed main conductor 20 and the filled container 2, and to reduce the overall size of the gas circuit breaker while ensuring the insulation performance required to cope with the discharge of the high-temperature gas.

### Second Embodiment

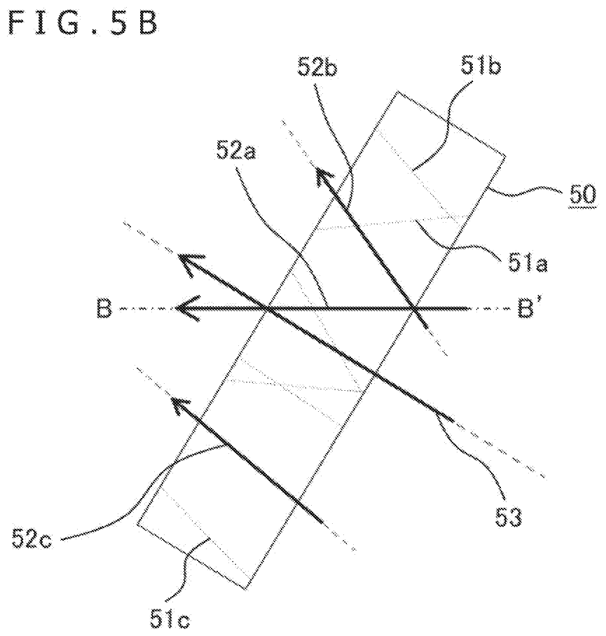

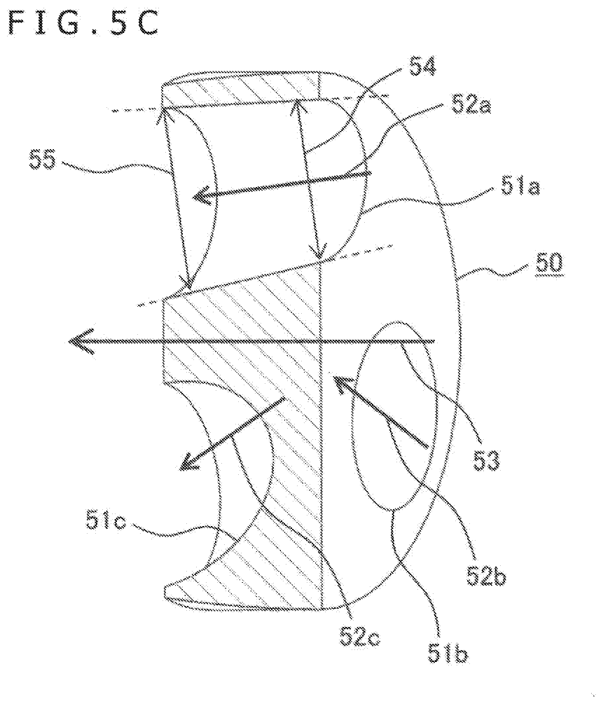

FIG. 5A, FIG. 5B and FIG. 5C illustrate a second embodiment of the gas circuit breaker according to the present invention. FIG. 5A, FIG. 5B and FIG. 5C are diagrams equivalent to FIG. 3A, FIG. 3B and FIG. 3C in the first embodiment.

The gas circuit breaker of the present embodiment illustrated in these diagrams is different from the gas circuit breaker explained in the first embodiment in that the flow-path cross-sectional area of each of the high-temperature-gas guiding holes 51a, 51b and 51c of the high-temperature-gas guiding section 50 orthogonal to the hole central axes is different between open sections at both ends of the high-temperature-gas guiding holes 51a, 51b and 51c (the inlet and outlet of each of the high-temperature-gas guiding holes 51a, 51b and 51c). That is, the flow-path cross-sectional area of each of the high-temperature-gas guiding holes 51a, 51b and 51c is larger at one end than at the other end.

Specifically, as illustrated in FIG. 5C, the high-temperature-gas guiding holes 51a, 51b and 51c do not have columnar shapes, but have tapered shapes. Thereby, a flow-path cross-sectional area 54 of the high-temperature-gas guiding hole 51a on the right side of FIG. 5C is smaller than a flow-path cross-sectional area 55 of the high-temperature-gas guiding hole 51a on the left side of FIG. 5C.

With such a configuration, it is certainly possible to attain effects that are similar to those in the first embodiment, and it is also possible to adjust the shape of distribution of the high-temperature gas at and downstream of the high-temperature-gas guiding section 50 simply, for example, by changing the hole diameters of the high-temperature-gas guiding holes 51a, 51b and 51c.

### Third Embodiment

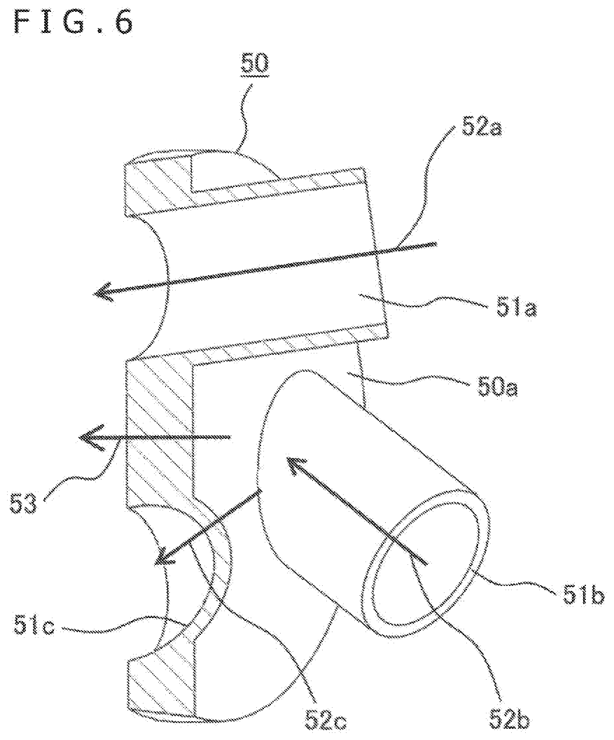

FIG. 6 illustrates a third embodiment of the gas circuit breaker according to the present invention.

The gas circuit breaker of the present embodiment illustrated in the diagram is different from the gas circuit breaker explained in the first embodiment in that the plurality of high-temperature-gas guiding holes 51a, 51b and 51c are realized in pipe-like shapes.

That is, although the plurality of high-temperature-gas guiding holes 51a, 51b and 51c are formed in the high-temperature-gas guiding section 50 in the first embodiment and the second embodiment mentioned above, the plurality of high-temperature-gas guiding holes 51a, 51b and 51c are formed in pipe-like shapes protruding from a base section 50a of the high-temperature-gas guiding section 50 in the present embodiment.

Specifically, as illustrated in FIG. 6, the high-temperature-gas guiding section 50 of the present embodiment includes the base section 50a of the high-temperature-gas guiding section 50, and the plurality of high-temperature-gas guiding holes 51a, 51b and 51c formed in pipe-like forms (three holes in the present embodiment) protruding from the base section 50a in the axial direction. The plurality of high-temperature-gas guiding holes 51a, 51b and 51c formed in pipe-like forms are formed such that the directions 52a, 52b and 52c of the plurality of high-temperature-gas guiding holes 51a, 51b and 51c are oblique to the axial direction 53 of the fixed main conductor 20.

The plurality of high-temperature-gas guiding holes 51a, 51b and 51c formed in the pipe-like forms described above are provided at approximately equal intervals in the circumferential direction of the high-temperature-gas guiding section 50.

In addition, in the present embodiment, the directions 52a, 52b and 52c of the pipe-like high-temperature-gas guiding holes 51a, 51b and 51c formed at approximately equal intervals in the circumferential direction of the high-temperature-gas guiding section 50 are formed such that the directions 52a, 52b and 52c of the pipe-like high-temperature-gas guiding holes 51a, 51b and 51c are oblique to the axial direction 53 of the fixed main conductor 20, and the axial direction 53 of the fixed main conductor 20 and the directions 52a, 52b and 52c of the high-temperature-gas guiding holes 51a, 51b and 51c do not cross, that is, the axial direction 53 and the directions 52a, 52b and 52c have a relationship of skew lines (the pipe-like high-temperature-gas guiding holes 51a, 51b and 51c have skew central axes such that the directions of the flows of the discharged high-temperature gas become unaligned). The high-temperature gas having passed through the pipe-like high-temperature-gas guiding holes 51a, 51b and 51c forms a gas flow having a swirling flow component in the circumferential direction orthogonal to the axial direction.

With such a configuration, it is certainly possible to attain effects similar to those in the first embodiment, and it is also possible to attain weight reduction since the thickness of the high-temperature-gas guiding section 50 is reduced as compared with the first embodiment and the second embodiment.

Note that in any of the embodiments described above, any processing method such as casting, 3D-printing or welding may be used for fabrication of the high-temperature-gas guiding section 50. In addition, each of the high-temperature-gas guiding holes 51a, 51b and 51c may have a different feature (the high-temperature-gas guiding holes 51a, 51b and 51c may have different hole diameters, there may be a small-diameter hole at the center of the three high-temperature-gas guiding holes 51a, 51b and 51c arranged in the manner illustrated in the first and second embodiments, and the like).

In addition, the central axes of the high-temperature-gas guiding holes 51a, 51b and 51c may not necessarily be defined as straight lines, but may be defined as certain curves. In that case, the directions 52a, 52b and 52c of the high-temperature-gas guiding holes 51a, 51b and 51c are defined at open ends of the high-temperature-gas guiding holes 51a, 51b and 51c that are open toward the filled container 2. That is, the directions 52a, 52b and 52c are defined by which directions the end open sections of the high-temperature-gas guiding holes 51a, 51b and 51c face.

Note that the present invention is not limited to the embodiments mentioned above, but includes various modification examples. For example, the embodiments mentioned above are explained in detail in order to explain the present invention in an easy-to-understand manner, and the present invention is not necessarily limited to embodiments including all the configurations explained. In addition, some of the configurations of an embodiment can be replaced with configurations of another embodiment, and configurations of an embodiment can be added to the configurations of another embodiment. In addition, some of the configurations of each embodiment can be subjected to addition, deletion or replacement of other configurations.

What is claimed is:

1. A gas circuit breaker that blows an insulating gas having an arc-extinguishing property onto an arc produced at a time of interruption, and extinguishes the arc, the gas circuit breaker comprising:
a filled container filled with the insulating gas;
a fixed main conductor that is connected to a fixed lead conductor connected to a power system, and has an open section for discharging the insulating gas having an increased temperature and an increased pressure due to the arc produced at the time of the interruption;
a movable main conductor that is supported by and fixed to an insulating support tube arranged inside the filled container, is connected to a movable lead conductor connected to the power system, and has a discharge hole for discharging the insulating gas;
a movable contact electrically connected to the movable lead conductor;
a fixed contact that is electrically connected to the fixed lead conductor connected to the power system, and can come into contact with and be separated from the movable contact; and
a high-temperature-gas guiding section that is provided at an axial-end section of the fixed main conductor, and has a plurality of holes for discharging, into the filled container, a high-temperature gas produced by heating the insulating gas, wherein
the high-temperature-gas guiding section is formed such that directions of the plurality of holes are oblique to an axial direction of the fixed main conductor.

2. The gas circuit breaker according to claim 1, wherein
the high-temperature-gas guiding section is provided integrally with or separately from the fixed main conductor.

3. The gas circuit breaker according to claim 2, wherein
the plurality of holes are provided at approximately equal intervals in a circumferential direction of the high-temperature-gas guiding section.

4. The gas circuit breaker according to claim 1, wherein
central axes of the plurality of holes have a relationship of skew lines, and the high-temperature gas having passed through the holes of the high-temperature-gas guiding section forms a discharge flow having a swirling component in a circumferential direction.

5. The gas circuit breaker according to claim 3, wherein
central axes of the plurality of holes have a relationship of skew lines, and the high-temperature gas having passed through the holes of the high-temperature-gas guiding section forms a discharge flow having a swirling component in a circumferential direction.

6. The gas circuit breaker according to claim 5, wherein
the plurality of holes have skew central axes such that directions of flows of the high-temperature gas discharged from the plurality of holes become unaligned.

7. The gas circuit breaker according to claim 6, wherein
each of the plurality of holes has a columnar shape.

8. The gas circuit breaker according to claim 1, wherein
each of the plurality of holes has a flow-path cross-sectional area orthogonal to a central axis of the hole, the flow-path cross-sectional area being a same at open sections at both ends of the hole or being smaller at one open section at an end of the hole than other open section at other end of the hole.

9. The gas circuit breaker according to claim 6, wherein
each of the plurality of holes has a flow-path cross-sectional area orthogonal to a central axis of the hole, the flow-path cross-sectional area being a same at open sections at both ends of the hole or being smaller at one open section at an end of the hole than other open section at other end of the hole.

10. The gas circuit breaker according to claim 9, wherein
each of the plurality of holes has a tapered shape.

11. A gas circuit breaker that blows an insulating gas having an arc-extinguishing property onto an arc produced at a time of interruption, and extinguishes the arc, the gas circuit breaker comprising:
a filled container filled with the insulating gas;
a fixed main conductor that is connected to a fixed lead conductor connected to a power system, and has an open section for discharging the insulating gas having an increased temperature and an increased pressure due to the arc produced at the time of the interruption;
a movable main conductor that is supported by and fixed to an insulating support tube arranged inside the filled container, is connected to a movable lead conductor connected to the power system, and has a discharge hole for discharging the insulating gas;
a movable contact electrically connected to the movable lead conductor;
a fixed contact that is electrically connected to the fixed lead conductor connected to the power system, and can come into contact with and be separated from the movable contact; and
a high-temperature-gas guiding section that is provided at an axial-end section of the fixed main conductor, and has a plurality of holes for discharging, into the filled container, a high-temperature gas produced by heating the insulating gas, wherein
the high-temperature-gas guiding section includes a base section, and the plurality of holes that are formed in pipe-like forms protruding from the base section in an axial direction, and is formed such that directions of the plurality of holes formed in the pipe-like forms are oblique to an axial direction of the fixed main conductor.

12. The gas circuit breaker according to claim 11, wherein
the plurality of holes formed in the pipe-like forms are provided at approximately equal intervals in a circumferential direction of the high-temperature-gas guiding section.

13. The gas circuit breaker according to claim 12, wherein
central axes of the plurality of holes that are formed in the pipe-like forms have a relationship of skew lines, and the high-temperature gas having passed through the holes of the high-temperature-gas guiding section forms a discharge flow having a swirling component in a circumferential direction.

14. The gas circuit breaker according to claim 13, wherein
the plurality of holes that are formed in the pipe-like forms have skew central axes such that directions of flows of the high-temperature gas discharged from the plurality of holes become unaligned.
